(19) United States
(12) Patent Application Publication
(10) Pub. No.: US 2009/0025038 A1
(43) Pub. Date: Jan. 22, 2009

(54) Methods and Apparatus for Updating a Favorite List of Channel Numbers

(76) Inventor: Rajeev Madhukar Sahasrabudhe, Fishers, IN (US)

Correspondence Address: Joseph J. Laks;Thomson Licensing LLC, 2 Independence Way, Patent Operations, PO Box 5312, PRINCETON, NJ, 08543, US

(21) Appl. No.: 12/223,768

(22) PCT Filed: Mar. 6, 2006
(86) PCT No.: PCT/US06/07900

§ 371 Date: Aug. 8, 2008

(51) Int. Cl. H04N 5/445

(52) U.S. Cl. 725/50

(57) ABSTRACT

This invention relates to a method and an apparatus for updating a favorite list of channel numbers in an electronic device, the method comprising the steps of: receiving channel update information comprising an existing channel number and a corresponding new channel number; determining if the existing channel number is in the favorite list; if the existing channel number is in the favorite list, removing the existing channel number from the favorite list and adding the corresponding new channel number to the favorite list. The apparatus for updating a favorite list of channel numbers comprises: a receiver for acquiring a television signal having information associated with one or more new channel number changes; memory for storing existing channel numbers; a mechanism to change the existing channel numbers to one or more new channel numbers, and an arrangement to feed back the changed channel numbers to a receiver of the television signal.

### FIELD OF INVENTION

The present invention relates generally to a method and apparatus for changing channel numbers in a channel list, and more specifically for managing favorite channel lists in a television viewing system when a service provider changes broadcast channel allocation within the available transmission frequencies.

### BACKGROUND

Cable and satellite providers typically offer many television viewing and audio channels to a subscriber. The subscriber or user of the television device can create a list of channels, for example, a favorites list or a channel block list, either in the set top box (STB) or in the display device that tunes to a specified frequency, or in a monitor that receives the video signal from a secondary tuning device such as the STB. The providers frequently change their channel lineup to introduce new channels, to effect changes requested by the user, such as the user subscribing to additional channels, to move channels to other frequencies of transmission to suit their broadcast lineup, or the like.

When the providers plan to make such a channel lineup change, they typically alert the user of the impending channel lineup change (e.g., channel #111 is moving to channel #123 on April. 17^{th}). When the channel number is moved, the transmission frequency also moves. The subscriber may learn about these moves in various ways. A notification can be made in the channel guide that is provided by the provider and is displayed via a message generated by an on-screen display processor (“OSD”). If the channel that is moving is in the user's favorite list and the favorite list is created using channel numbers as a unique identifier (“unique ID”) then once the channel lineup takes effect, the prior systems fail to update the user's favorite list automatically. A mechanism for alleviating this problem is desired.

### SUMMARY OF THE INVENTION

The present invention pertains to a method for updating a favorite list of channel numbers in an electronic device, the method comprising the steps of: receiving channel update information comprising an existing channel number and a corresponding new channel number; determining if the existing channel number is in the favorite list; if the existing channel number is in the favorite list, removing the existing channel number from the favorite list and adding the corresponding new channel number to the favorite list.

The present invention also pertains to an apparatus for updating a favorite list of channel numbers comprising: a mechanism for acquiring a television signal having information associated with one or more new channel number changes; a memory having therein contained corresponding existing channel numbers; a mechanism to change the existing channel numbers to one or more new channel numbers, and an arrangement to feed back the changed channel numbers to a receiver of the television signal.

### BRIEF DESCRIPTION OF THE DRAWINGS

The invention may be understood from the following detailed description when read in connection with the accompanying drawing. The various features of the drawings are not specified exhaustively. The various features may be arbitrarily expanded or reduced for clarity.

FIG. 1 represents a block diagram of a television system incorporating the subject invention.

FIG. 2 represents a process flow according to an embodiment of the present invention.

FIG. 3 represents another process flow according to an embodiment of the present invention.

FIG. 4 represents another process flow according to an embodiment of the present invention.

FIG. 5 represents another process flow according to an embodiment of the present invention.

FIG. 6a represents another process flow according to an embodiment of the present invention.

FIG. 6b represents another process flow according to an embodiment of the present invention.

### DETAILED DESCRIPTION

It is to be understood that the figures and descriptions of the present invention have been simplified to illustrate elements that are relevant for a clear understanding of the present invention, while eliminating, for the purpose of clarity, many other elements found in set top box systems. Those of ordinary skill in the art may recognize that other elements and/or steps are desirable and/or required in implementing the present invention. However, because such elements and steps are well known in the art, a detailed discussion of such elements and steps is not provided herein. Furthermore, in the figures to be discussed, the circuits and associated blocks and arrows represent functions of the process according to the present invention, which may be implemented as electrical circuits and associated wires or data busses, which transport electrical signals. Alternatively, one or more associated arrows may represent communication (e.g., data flow) between software routines, particularly when the present method or apparatus of the present invention is a digital process.

Receiver systems allow the user to create favorite lists using unique IDs such as the guide codes for a particular broadcast channel and allow for automatic updates to the users favorite lists, but this occurs only if the favorite list was created in the STB generally supplied by the provider. If the user has created the favorite list in the device that tunes to a particular frequency on the basis of a channel number, i.e., the device simply receives the video signal from a secondary tuning device, such as a STB, then the automatic update does not take place as the unique ID for the favorite list the user creates in the display is most often the channel number of that channel rather than the guide code. Further, if the STB that allows the user to create favorite lists within the STB is using the channel number as the unique ID, rather than the guide code for a particular channel, then the automatic update does not take place.

Methods for allowing subscribers to create favorite channel lists are well known, for example, in U.S. Pat. No. 5,103,314 entitled “Color-Coded System For Selection of RF Input Terminals and Associated Scan Lists” which describes a system and method for allowing a user to enter and view a list of preferred channels.

Typically the channels in the favorite list are the channels the user can tune using the “CH−/+” buttons, either on the remote control or on the product front panel buttons. As an example, if the channel numbers 02 and 20 are in a user's favorite list but the channel numbers 04 and 05 are not, and if the user is currently tuned to channel 03 and presses the channel “+” button on the remote control device, then the CE device will tune to channel 06. The user is allowed however to tune to channels 04 and 05 via direct digit entry. Multiple channel lists may be set up, and a user may select a particular one of the channel lists to use.

If the service provider moves the broadcast on the frequency associated with channel 02 to channel 04 and the favorite list is on the receiver where the unique ID for the favorite list is that channel number itself, then the user will lose the broadcast on channel 02 that was in its favorite list, as channel 04 will not automatically get transformed into a corresponding coded (analog or digital) representation and added to the favorite list. The user would have to manually add the corresponding coded (analog or digital) representation of channel 04 to the favorite list and delete channel 02, if he does not want to retain the new broadcast on channel 02 in its favorite list. This would also be true if the favorite list is on a CE device not supplied by the service provider such as a television, and the user favorite list is on the non-supplied CE device.

This is all the more important if parents have created favorite lists for their children to watch and have blocked other channels from being in the children's list. Currently, if the provider changes the lineup and a channel that the parents do not want their children to watch is moved to a channel in the children's favorite list, then the parents may not be aware that a channel unintended for their children's access is available for viewing. The present invention alleviates this problem.

In accordance with an aspect of the invention, the user's favorite list will automatically get updated once the broadcast channel move has taken place. In one embodiment the new channel may be added to the user's favorite list before the broadcast channel actually changes (for example, 24-48 hours in advance), but the new channel is excluded from the “CH−/+” loop, until the broadcast actually moves to that new channel number. In another embodiment the user may be prompted about the change, before it takes place, and also may be prompted about the new broadcast that the old channel number is now carrying. Furthermore, the user may be prompted to retain the new broadcast, and effectively retain the corresponding channel number in its favorite list, or be provided the option of discarding it.

For the system to ascertain that the channel lineup has changed, the system could refer to the guide data or obtain the data from information transmitted on the vertical blanking interval (“VBI”). Thus, if the user has created its favorite list on a monitor rather than the device that is actually tuning to the available channels, the tuning device can relay the information it receives via the guide data or the VBI to the monitor. This may be achieved via various known and available ways of communication between the tuning device and the monitor as is understood by one skilled in the art. The monitor may be programmed to provide an OSD indicating when a channel lineup change is scheduled to take place to update the channel list. If the user has created a channel list in the device that tunes to the channels, then the device may have its own OSD provided on the viewing monitor and is triggered by the tuning device itself. Any associated action that the user takes is communicated back to the tuning device, either directly, or via transmission by the monitor to the tuning device using known methods.

An apparatus in accordance with an aspect of the invention for changing channel numbers in the favorite channel list comprises a receiver for acquiring information associated with a new channel number change; a memory having contained therein data representing an existing channel number; means for changing the data representing existing channel number to data representing a new channel number, and an arrangement to change a frequency corresponding to the data representing the channel number of a receiver. The apparatus as described allows for the automatic favorite list update either via a prompt, followed by user action, or without user action. This is in contrast to the passive system currently in use that merely displays the channel lineup change information, while requiring the user to edit the favorite list.

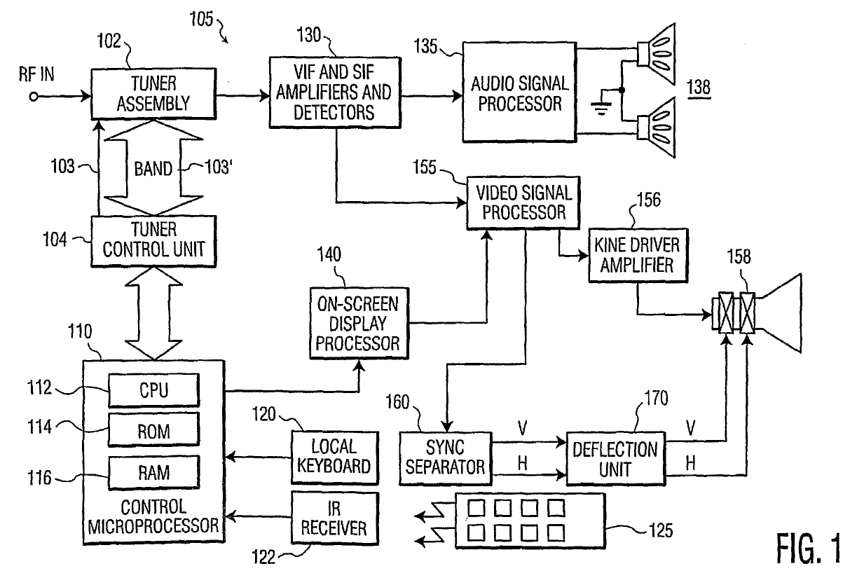

An exemplary arrangement for implementing the present invention is shown in FIG. 1. Referring to FIG. 1, radio frequency (RF) signals are applied to an RF input terminal of tuner assembly 102. Tuner assembly 102 selects and amplifies a particular RF signal under control of a tuner control unit 104 which applies a tuning control signal to tuner assembly 102 via a wire 103, and applies bandswitching signals via a control bus 103′. Tuner control unit 104 is controlled by a controller 110. Controller 110, which may be a microprocessor or microcomputer, includes a central processing unit (CPU) 112, a read-only memory (ROM) 114, and a random access memory 116. Controller 110 generates the above-mentioned control signal for RF switch 100 for selecting an RF input for tuner 102. Controller 110 receives user-entered control signals from a local keyboard 120 and from an infrared (IR) receiver 122. IR receiver 122 receives and decodes remote control signals transmitted by a remote control unit 125.

Tuner 102 produces a signal at an intermediate frequency (IF) and applies it to a processing unit 130 comprising a video IF (VIF) amplifying stage, an AFT circuit, a video detector, and a sound IF (SIF) amplifying stage. Processing unit 130 produces a baseband composite video signal (TV), and a sound carrier signal. The sound carrier signal is applied to an audio signal processor unit 135 which includes an audio detector and a stereo decoder. Audio signal processor unit 135 produces baseband left and right audio signals and applies them to air of speakers 138 for sound reproduction.

The baseband video signal (TV) is coupled to a video processor unit 155 and a kine driver amplifier 156, and ultimately displayed on a display screen of a display device 158. Video signals are also applied to a sync separator unit 160 which derives vertical and horizontal synchronizing signals therefrom. The derived vertical and horizontal signals are applied to a deflection unit 170 for the production of deflection signals for application to the yoke assembly of display device 158. Under control of controller 110, an on-screen display processor 140 generates character signals, and applies them to a second input of video signal processor 155, for display on display device 158.

In one configuration, memory 116 is operative to receive and update one or more lists (e.g. scan or favorite lists) of corresponding existing channel numbers. The remote control device 125 in combination with controller 110, is operable (via for example, a keypad on the remote control) to change the existing channel numbers to one or more new channel numbers, and to feed back the changed channel numbers to alter the receiver tuner frequencies of television reception.

More particularly, in an exemplary embodiment, the favorite channel list is stored in memory 116, which may comprise non-volatile erasable memory such as an EEPROM. Change channel numbers are communicated from the service provider via one or more signals received at the receiver 105 and provided to processor 110. The processor 110 compares the program channel change information received to the favorite channel list as stored in memory 116 and determines if a corresponding channel number has been deleted or added by the subscriber. In the illustrative system, the OSD processor 140 outputs a display having the changed channel number to the user and the tuner 102 may be correspondingly controlled so as to correlate the change in the channel number associated with a particular channel preference.

In an another configuration, if the favorite list is not stored in memory 116 but rather in a memory of a remote device such as a monitor (i.e. instead of the device that is actually tuning to the available channels) the receiver tuning device in operative communication with the monitor may provide or relay the information it receives via the guide data or VBI to the monitor for update and storage in the monitor memory.

In an embodiment of the invention, the channel change information is transmitted in data packets embedded in the television signal by transmitting them during the video blanking interval. In North America, the video blanking interval comprises lines 10 through 21 of a video signal. Preferably, the data packets comprise data bytes transmitted in the Extended Data Services (“XDS”) portion of a video signal. XDS data is transmitted in line 21 of the video signal as defined by Electronic Industries Association specification No. EIA-608, which is incorporated herein by reference. It is desirable to use line 21 because almost all new television sets sold in the North America are required to have a built-in decoder for XDS data transmitted on line 21.

Specification No. EIA-608 specifies protocols for embedding digitally encoded information packets containing information about a television program, which is being currently broadcast, along with additional data as specified by the broadcaster. Each XDS data packet begins with a “start” character, which also indicates the “class” of the information (i.e. generally what the information in the packet relates to). For example: the start character for data about a current program (the “Current” class) is 01h; the start character for data about the current channel (the “Channel Information” class) is 05h; and, the start character for “undefined” data (the “Undefined” class) is 0Dh. A data type character which indicates the specific nature of the information being transmitted follows the start character. Each information packet ends with an “end” character, which is defined in EIA-608 to be 0Fh, and a checksum character.

EIA-608 defines codes for transmitting information that is useful for practicing the invention. Other information for practising the invention can be conveniently transmitted as XDS data using the undefined data type provided by EIA-608. Of course, this or similar information could also be encoded and transmitted in ways which do not conform with the EIA-608 specification. It will be readily apparent to those skilled in the art that the invention could be practiced with other protocols and/or by encoding and embedding any necessary data in video signal using other encoding and/or embedding techniques. What is important is that the incoming video signal have somehow embedded in it codes which convey at least some of the information described below.

There are four classes of packets currently defined: Current, Future, Network, and Miscellaneous. The Current packet contains information describing the program currently being transmitted. The Future packet contains information about an upcoming program to be transmitted. The Network packet contains information about the source of the video signal, e.g. the broadcasting network. The Miscellaneous packet contains a variety of other useful information.

Each packet conveys one piece of information. In accordance with the present invention, an undefined data type may be used to convey the channel change information. In that regard, the receiver would recognize that channel change information is conveyed in the data packets that follow, wherein the data packet may be provided in a predefined format that is recognized by the receiver, for example, old channel number, new channel number, date of change, etc. Once the information is received and recognized, the receiver may perform the automatic updating of the favorite channels list as described below.

In a digital environment, the channel change information may also be provided via program and system information tables that are multiplexed with the program information. For example, program and system information protocol (“PSIP”) is well known in the pertinent arts, and is presented in the Advanced Television Systems Committee (ATSC) Document A/65-B, entitled “Program and System Information Protocol for Terrestrial Broadcast and Cable”, dated Mar. 18, 2003, the entire disclosure of which is also hereby incorporated by reference herein. By way of non-limiting explanation, the PSIP is a collection of hierarchically-associated tables each of which describes particular elements of typical Digital Television (DTV) services. The base tables include: the System Time Table (STT), the Rating Region Table (RRT), the Master Guide Table (MGT), and the Virtual Channel Table (VCT). A Directed Channel Change Table (DCCT) and Directed Channel Change Selection Code Table (DCCSCT) may also be included. Event Information Tables (EITs) may also be included as part of the PSIP data structures.

The System Time Table (STT) carries time information for applications requiring synchronization. The Rating Region Table (RRT) defines rating tables valid for different regions or countries. The Master Guide Table (MGT) defines sizes, packet identifiers (PIDs) and version numbers for tables. The Virtual Channel Table (VCT) tabulates virtual channel attributes required for navigation and tuning. The invention may utilized undefined fields in, for example, the VCT to convey the channel change information. Again, the receiver is programmed to recognize a specified code that denotes channel change information, then uses that information to change the favorite channel list, or to provide a display that enables the user to change the favorite channel list as described below.

A process for carrying out the steps of the invention for updating a favorite list of channel numbers comprises the steps of: acquiring a video signal, or a television signal, having information associated with one or more new channel number changes; storing existing channel numbers; changing the existing channel numbers to one or more new channel numbers, and feeding back the changed channel numbers to a receiver of the television signal if necessary.

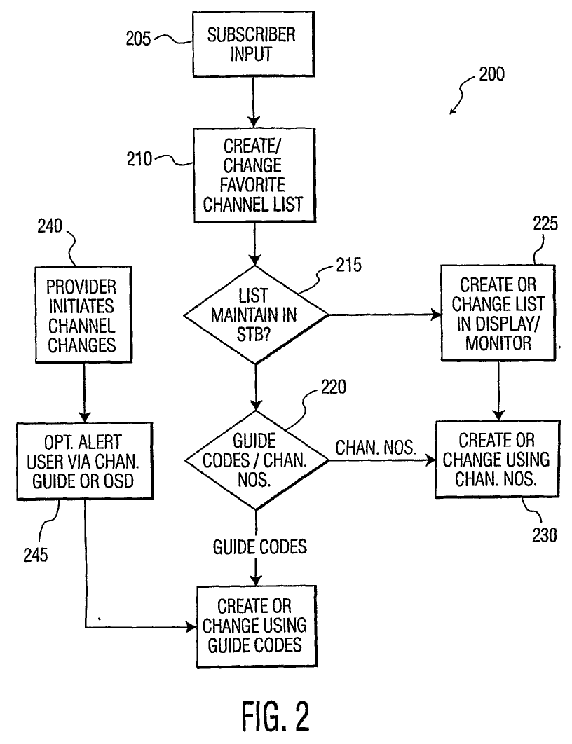

Referring now to FIG. 2, a subscriber input 205 using the remote control 125 may create or change the favorite channel list 210 stored in the memory 116 of the receiver such as a set top box, or alternatively in the memory of a remote monitor device operatively coupled to the tuning device. In the illustrative embodiment, if the STB memory retains the favorite channel lists, the favorite lists are represented as corresponding guide codes or as channel numbers. If the list is maintained 215 as guide codes as determined in block 220, then any change must be made to the guide codes. Changing the guide codes 235 is typically achieved automatically 240 by the service provider. In some cases the service provider may also optionally alert 245 the subscriber via text message or other means of communication. With reference to FIG. 1, receiver 105 includes as part of control microprocessor 110 (or another processor) a program information decoder, which stores the program information such as guide codes into memory 116. The program information decoder and memory 116 for storing the decoded program information provides input to the OSD 140 for displaying the programming information on the picture display device 158.

In the case where the means for storing is not located in the set top box, but resides in a remote monitor memory or the television device itself (not shown), then channel numbers designate the favorite channels and the change 225 is made in the monitor memory or the television device itself (not shown). Likewise, if the list is maintained 215 in the STB as channel numbers, as determined 220, then a change 230 is made to the channel numbers. In this last instance, the subscriber 205 again makes the change.

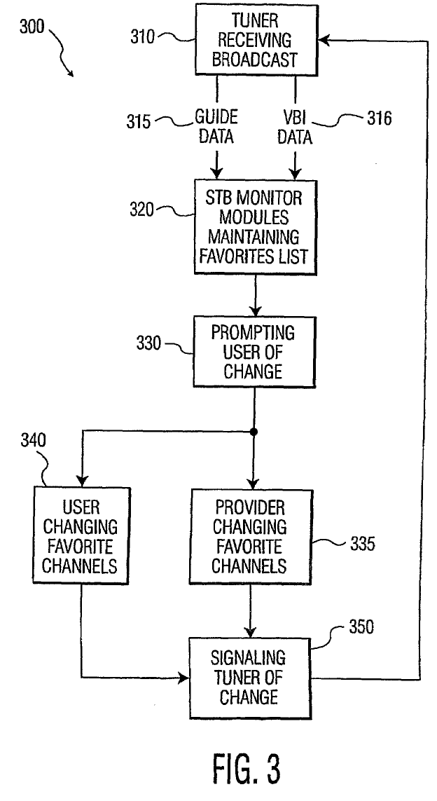

Referring now to FIG. 3, there is shown a process flow whereby the tuner 102 receives a composite broadcast signal having video, audio and information content. The information content may include channel information as one or both guide data 315 and vertical blanking information containing channel number data 316 that is received by the STB or the monitor that maintains modifiable favorite channel lists. The favorite channel information may prompt the subscriber 330 of a change or impending change. The provider may thereafter change the channel 335, which will have the effect of changing where the favorite channel list points relative to the new change. The user may effectively nullify the change by modifying 340 the favorite channel list so as to correspond to the previous location. In the course of changing the favorite list, the monitor, set top box or television then signals 350 the tuner of the change made.

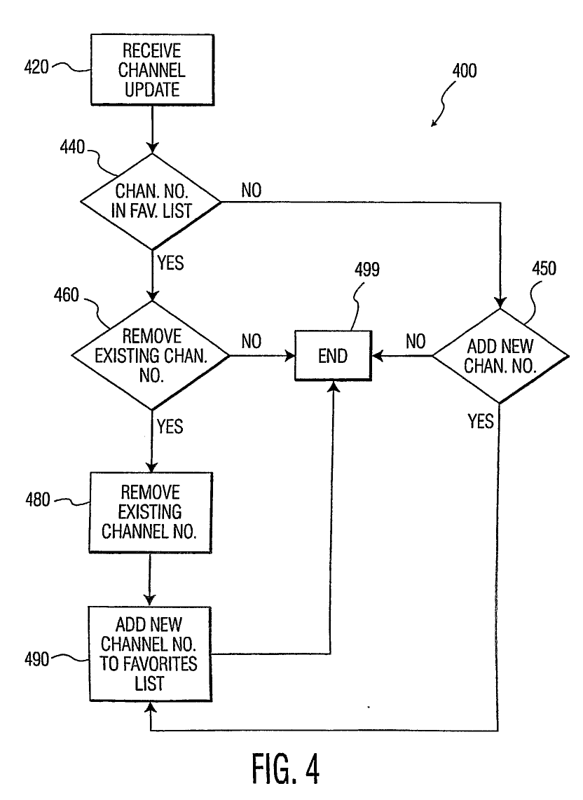

As illustrated in FIG. 4, one embodiment of the present invention relates to a method for receiving information from the service provider about a new channel number. The method 400 allows for changing favorite channels lists when the service provider changes broadcast channels or alters programming specific to a channel. The method comprises the steps of: receiving 420 channel update information including a corresponding new channel number; determining 440 if the existing channel number is in the favorite list; if the existing channel number is in the favorite list, determining 460 if the subscriber desires to remove the existing channel number. If the subscriber does not wish to remove the existing channel number the process ends 499. Otherwise, the subscriber removes 480 the existing or old channel number and adds 490 the corresponding new channel number to the favorite list. In step 440 it may be determined that the channel number is not in the favorite channel list and the process proceeds to step 450 to decide whether the subscriber desires to make a change by adding the new channel to the favorite list.

More specifically, referring to FIG. 1 in conjunction with FIG. 4, the receiver 105 receives channel update information 420 that a channel change will go into effect on a specified date. The new channel and date and time it takes effect are stored in memory 116. The processor 110 determines 440 if the channel number is in the favorite list and informs the user by providing the OSD that informs the user of the scheduled change. If the channel number is in the favorite list and the user desires to remove the existing channel number 460 the user utilizes the remote control 125 to input a command, which is processed in association with processor 110 to remove 480 the existing channel. If additionally user desires to add a new channel in place of the proposed channel change, the user can utilize the remote control 125 to input a command, which is processed by in association with processor 110, to add 490 the new channel. The display may comprise a button, or a selectable portion of the display, that when selected by the user automatically makes the necessary changes to the favorites list, that is, adding the new channel when the channel change takes effect.

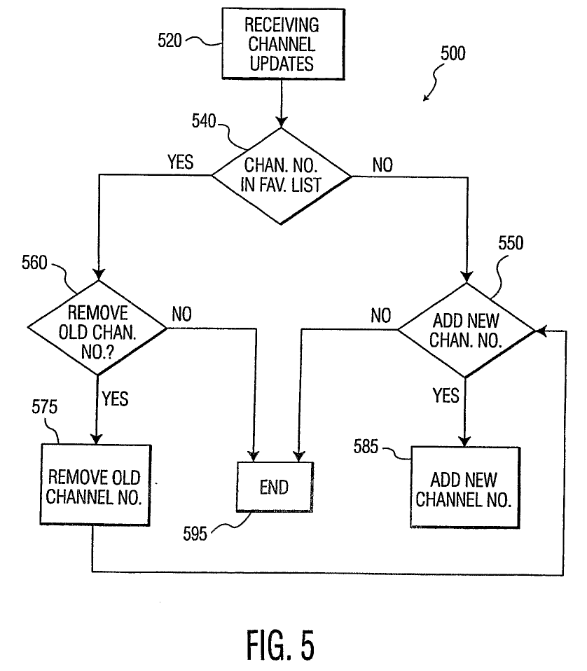

As illustrated in FIG. 1 and FIG. 5, one embodiment of the present invention relates generally to a method receiving information from the service provider about a new channel number. The method 500 allows for changing favorite channels and lists when the service provider changes broadcast channels or alters programming specific to a channel. The receiver 105 receives channel update information 520 that a channel change will go into effect on a date certain. The new channel and date and time it takes effect are stored is memory 116. The processor 110 determines 540 if the channel number is in the favorite list and informs the user by providing an OSD that informs the user of the scheduled change. The change may comprise changing the frequency or channel number associated with channel numbers in a favorites list. If an affected channel number is in the favorite list and the user desires to update the favorites list, the user may select to automatically update the favorite channel list by selecting a designated button, or portion of display, on the OSD. For example, the OSD may display an “ACCEPT” button, which automatically causes the processor to edit the favorites list when the channel change takes place.

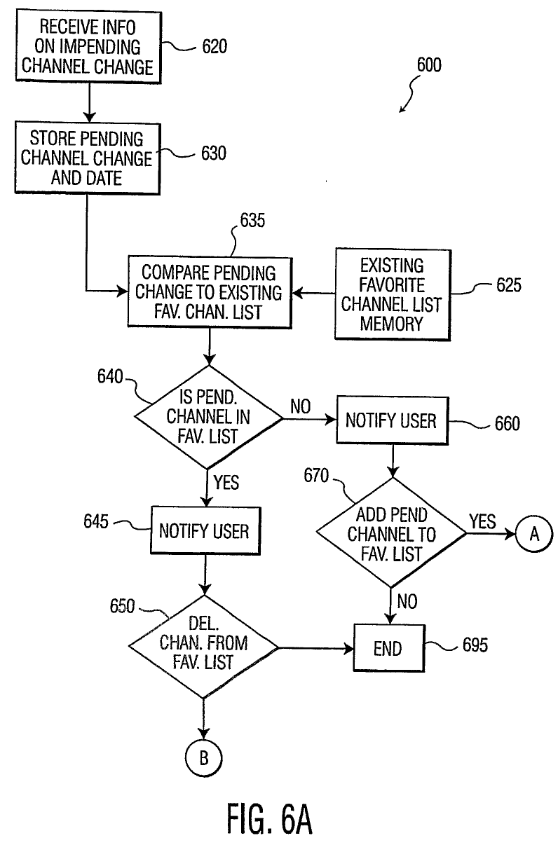

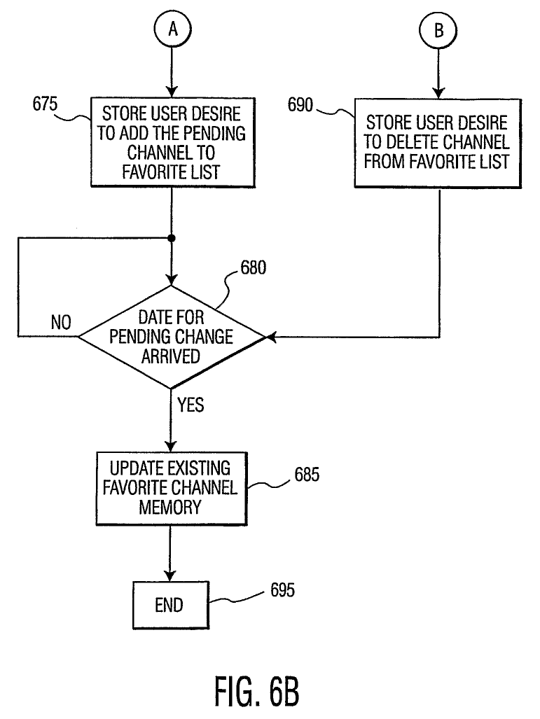

As illustrated in FIG. 1, FIG. 6a and FIG. 6b, another embodiment of the present invention relates generally to a method receiving information from the service provider about a new channel number. In process 600 the user is prompted about the change, before it takes place, and prompted about the new broadcast that the old channel number is now carrying. Furthermore, via the remote control 125 or other suitable device, the user prompts the system 100 to retain the new broadcast, and effectively retains the corresponding channel number in its favorite list, or discards the channel number in the list. The process 600 allows for changing favorite channel lists when the service provider changes broadcast channels or alters programming specific to a channel. The receiver 105 receives channel update information 620 that a channel change will go into effect on a specified date. In step 630, the pending channel change information comprises the channel number, and the date the change will take effect, both of which are processed by the program information decoder and stored in memory 116. The processor 110 accesses the existing favorite channel list memory stored in memory 116 and compares 635 the pending change against the favorite channel list and determines 640 if the channel number is in the favorite list and informs the user in steps 645 and 660 by providing an OSD informing the user of the scheduled change. If the existing channel number is in the favorite list and the subscriber desires to delete the pending channel number 650 from the favorite list, the user utilizes the remote control 125 to input a command that causes processor 110, to delete 690 the existing and pending channel. The processor reads the memory 116 and determines if the date for the pending change has arrived 680. If the date has arrived the processor updates the favorite channel memory. If the existing channel number is not in the favorite list, the user can utilize the remote control to input a command, allowing processor 110 to determine 670 if the subscriber desires to add 670 the new pending channel number. The command may be selected by selecting a designated button, or portion, of the OSD. If the subscriber desires to add the new number to the favorite list then the processor 110 performs step 675. The processor reads the memory 116 and determines if the date for the pending change has arrived 680. If the date has not arrived the processor continues to read the memory 116 and to determine if the date for the pending change has arrived 680 and when the date has arrived it updates the favorite channel memory. If the subscriber desires to not to add the new number to the favorite list then processor 110 goes to step 695, terminating the process 600. If the existing channel number is in the favorite list, and the user, utilizing the remote control 125 inputs a command to allow processor 110 to determine 650 that the user does not desire to delete the new pending number from the favorite list. The processor then goes to step 695, terminating the process 600.

In an alternative embodiment, the program information decoder or processor may communicate the pending channel number change and date the change takes effect via an input/output bus to a remote monitor operatively coupled to the tuning device, which includes a memory for updating the channel number information therein.

In an alternative embodiment, the receiver may include a plurality of channel number lists. For example, certain STBs and television receivers enable a user to set up several favorite channel lists, for example, each list being associated with a specific user, or a specific purpose such as sports programming. In this regard, the present invention may be arranged to allow the user to select which lists will be automatically updated. An on screen display may be provided to the user to allow the user to select specific lists for updating, either on a default basis or when the channel change update information is received. The default mode may be selected using a system set up menu or the like, in which the user select the automatic updates to be performed in response to the channel change information without further input from the user. In that case, the on screen display merely serves to provide information to the user that a change to the channel number list will occur.

As will be apparent from those skilled in the art, the order of various determinations such as whether to remove the existing channel number prior to adding a new channel number will be a design choice may be modified as desired.

It is understood that the entire system 100 or portions thereof can be implemented in hardware, software, firmware, or combinations thereof. In a preferred embodiment, the system 100 functionality and means for changing channel numbers and managing channel lists may be implemented in software stored in a memory such as memory 116. It is to be appreciated that, where the functionality selection is implemented in either software, firmware, or both, the processing instructions can be stored and transported on any computer-readable medium for use by or in connection with an instruction execution system, apparatus, or device, such as a computer-based system, processor-containing system, or other system that can fetch the instructions from the instruction execution system, apparatus, or device and execute the instructions.

Further, it is understood that the subject invention may reside in the program storage medium that constrains operation of the associated processors such as controller 104 and processor 110, and in the method steps that are undertaken by cooperative operation of the processor(s) on the messages within the signal and data processing network. These processes may exist in a variety of forms having elements that are more or less active or passive. For example, they exist as software program(s) comprised of program instructions in source code or object code, executable code or other formats. Any of the above may be embodied on a computer readable medium, which include storage devices and signals, in compressed or uncompressed form. Exemplary computer readable storage devices include conventional computer system RAM (random access memory), ROM (read only memory), EPROM (erasable, programmable ROM), EEPROM (electrically erasable, programmable ROM), flash memory, and magnetic or optical disks or tapes. Exemplary computer readable signals, whether modulated using a carrier or not, are signals that a computer system hosting or running the computer program may be configured to access, including signals downloaded through a satellite system, cable network, DSL, associated with the Internet or other networks. Examples of the foregoing include distribution of the program(s) on a CD ROM or via Internet download.

The foregoing description of various embodiments is provided to enable any person skilled in the art to make or use the present invention. Various modifications to these embodiments will be readily apparent to those skilled in the art, and the generic principles defined herein may be applied to other embodiments. Thus, the present invention is not intended to be limited to the embodiments shown herein but is to be accorded the widest scope consistent with the principles and novel features disclosed herein.

1. A method for updating a channel number list in an electronic device, comprising the steps of:
receiving channel update information comprising an existing channel number and a corresponding new channel number;
determining if the existing channel number is in the channel number list; and
if the existing channel number is in the channel number list, removing the existing channel number from the number list and adding the corresponding new channel number to the channel number list.

2. The method of claim 1, further comprising the step of:
determining the date when the channel number change will occur, and the removing step comprises removing the existing channel number from the channel number list and adding the new channel number to the channel number list on the date when the channel number change occurs.

3. The method of claim 2, wherein the channel update information is received via extended data transmitted in the vertical blanking interval.

4. The method of claim 2, wherein the channel update information is received via one of a program guide and a program and system information protocol.

5. The method of claim 2, further comprising the step of providing an on screen display signal for enabling a user to select automatic update of the channel number list in response to the channel update information.

6. The method of claim 2, further comprising the step of providing an on screen display signal for enabling a user to select a default mode in which automatic update of the channel number list occurs in response to the channel update information without user action.

7. The method of claim 2, wherein the channel number list comprises a plurality of channel number lists, further comprising the step of providing an on screen display signal for enabling the user to select particular ones of the channel number lists to be updated in response to the channel update information.

8. An apparatus for changing channel numbers in a channel number list comprising: a receiver, a decoder and a memory for receiving pending channel number change information including at least one channel number change comprising an existing channel number and a corresponding new channel number, and a date the at least one channel number change takes effect, and a processor that accesses a memory having contained therein the channel number list, the processor comparing the existing channel number against the channel number list and generating an on screen display signal informing a user whether the existing channel number is in the favorite list.

9. The apparatus of claim 8, wherein the processor changes one or more of the channel numbers in the channel numbers list on the date a channel change takes effect in response to the channel number change information.

10. The apparatus of claim 9, wherein the receiver is adapted to receive the channel number change information via data transmitted on the vertical blanking interval.

11. The apparatus of claim 9, wherein the receiver is adapted to receive the channel number change information via a program guide or a program and system information protocol.

12. The apparatus of claim 9, wherein the processor generates an on screen display signal for enabling a user to select automatic update of the channel number list in response to the channel change information.

13. The apparatus of claim 9, wherein the processor generates an on screen display signal for enabling a user to select a default mode in which the automatic update of the channel number list occurs in response to the channel change information without user input.

14. The apparatus of claim 9, wherein the channel number list comprises a plurality of channel numbers lists, and the processor provides an on screen display signal for enabling a user to select particular ones of the plurality of channel change lists to be updated in response to the channel change information.
